(19) United States
(12) Patent Application Publication
(10) Pub. No.: US 2012/0081294 A1
(43) Pub. Date: Apr. 5, 2012

(54) APPARATUS AND METHOD FOR PROVIDING KEYBOARD FUNCTIONALITY, VIA A LIMITED NUMBER OF INPUT REGIONS, TO A SEPARATE DIGITAL DEVICE

(76) Inventors: Quang Sy Dinh, Hanoi (VN); Tan Le, San Francisco, CA (US)

(21) Appl. No.: 13/247,936

(22) Filed: Sep. 28, 2011

Related U.S. Application Data
(60) Provisional application No. 61/387,363, filed on Sep. 28, 2010.

(51) Int. Cl. G06F 3/02

(52) U.S. Cl. 345/169

(57) ABSTRACT

One embodiment includes an apparatus that receives gesture-based touch inputs from a user to provide keyboard functionality, via a limited number of input regions, to a separate digital device. The apparatus comprises: a touch-sensitive array; a processor; a communication module; and a casing. The touch-sensitive array defines a first zone with a plurality of radially-arranged touch regions, wherein the touch-sensitive array detects user touches at the regions of the first zone. The processor communicates with the touch-sensitive array, and distinguishes between various user input types for each region of the first zone. The processor generates an output that is a character associated with the input type. The communication module transmits the output to the separate digital device. The casing substantially houses the processor, the communication module and the touch-sensitive array.

### CROSS-REFERENCE TO RELATED APPLICATIONS

This application claims the benefit of U.S. Provisional Application No. 61/387,363, filed 28 Sep. 2010, which is incorporated in its entirety by this reference.

### TECHNICAL FIELD

This invention relates generally to the input device field, and more specifically to a new and useful method and apparatus for an apparatus and method for receiving gesture-based touch inputs from a user in the input device field.

### BACKGROUND

Computing devices are continually becoming smaller. At the same time, individuals are performing more engaging interactions with mobile devices, such as typing emails and performing tasks previously reserved for desktop computers. However, most input devices in the mobile computing space take inputs from capacitive touch screens with virtual keyboards or from physical keyboards with physical buttons. These input devices are limited by the additional size and the additional cost of incorporating a physical keyboard. Additionally, increasingly complex input devices place greater requirements on supporting processors. Thus, there is a need in the input device field to create a new and useful apparatus and method for facilitating gesture-based touch input to provide keyboard functionality to computing devices without adding to the cost, complexity, and size of these devices. This invention provides such a new and useful apparatus and method.

### BRIEF DESCRIPTION OF THE FIGURES

FIG. 1 is a plan view of a preferred embodiment of the invention;

FIG. 2 is an elevation section view, along section line A-A′ of FIG. 1, of a preferred embodiment.

FIG. 3 is a schematic representation of tracings of a touch sensitive array of a preferred embodiment;

FIGS. 4A and 4B are tables of exemplary gesture-to-key assignments;

FIG. 5 is a perspective view of a form factor of a preferred embodiment;

FIG. 6 is a flowchart of a usage scenario of a preferred embodiment;

FIG. 7 is a flowchart of a method of a preferred embodiment;

FIGS. 8A-8C are schematic representations of exemplary transitions; and

FIGS. 9A and 9B are schematics of alternative zone and segment arrangements of the touch-sensitive array.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Apparatus for Providing Keyboard Functionality

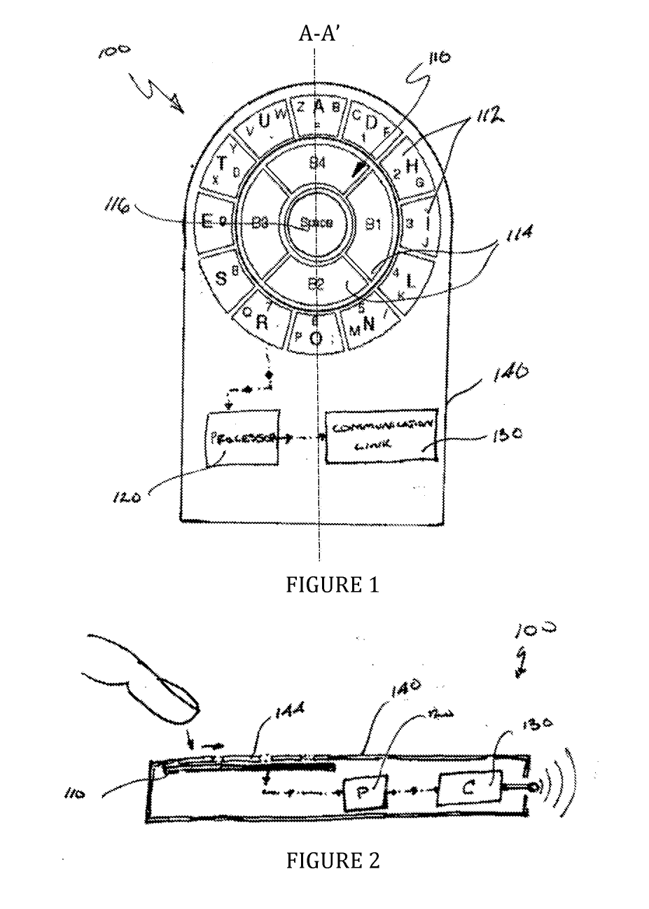

As shown in FIG. 1, an apparatus 100 of the preferred embodiment receives gesture-based touch inputs from a user to provide keyboard functionality, via a limited number of input regions, to a separate digital device. The apparatus 100 includes: 1) a touch-sensitive array 110 defining a first zone 112 with a plurality of radially-arranged touch regions, wherein the touch-sensitive array 110 detects user touches at the regions of the first zone 112; 2) a processor 120 in communication with the touch-sensitive array 110, wherein the processor 120 distinguishes between various user input types for each region of the first zone 112 and generates an output that is a character associated with the input type; 3) a communication module 130 that transmits the output to the digital device; and 4) a casing 140 that houses the processor 120 and communication module 130 and that further substantially covers the touch-sensitive array 110. The processor 120 preferably distinguishes between various user inputs, including: a first input type for a user tap on a region of the first zone 112; a second input type for a user touch on the region of the first zone 112 followed by a swipe in the counterclockwise direction and a touch release; and a third input type for a user touch on the region of the first zone 112 followed by a swipe in the clockwise direction and a touch release. The touch-sensitive array 110 may further define additional zones with additional touch regions, wherein the processor 120 distinguishes between additional user input types based upon user touch interactions with the additional regions. The apparatus 100 may additionally include a plurality of labels on each touch region to indicate characters corresponding to touch transitions between regions (i.e. gestures).

The apparatus 100 functions to provide a gesture-based character input mechanism for a digital device, wherein the apparatus 100 is of a form factor that is suitable for low cost solutions or in devices with small profiles. The apparatus 100 is preferably composed of radially-arranged buttons defined by touch regions of the touch-sensitive array 110. A wide variety of characters may be selected by tapping on a region and/or by sliding a finger (or stylus) from a first region to a second region. The touch-sensitive region is preferably substantially circular (i.e. the touch-sensitive array 110 defines radially-arranged touch regions); this radial/circular arrangement preferably functions to simplify the gesture inputs recognized by the apparatus 100 (e.g., the processor 120. This arrangement of the regions preferably enables a small number of touch regions to provide a wide variety of character inputs, and the processor 120 may further generate an output that is a command, wherein the command controls a function of the digital device and is associated with an input type such that the small number of touch regions may further provide a wide variety of command inputs. The apparatus 100 may be used: 1) for any suitable digital device such as a phone keypad or as a computer keyboard; 2) as a remote control for a television, a gaming console, a DVD player, a stereo, a phone, a smartphone, a tablet computer, a laptop computer, a desktop computer, an e-reader, and a wireless router; or 3) in conjunction with any other digital device. However, the digital device is preferably a computing device and is preferably separate from the apparatus 100. As an exemplary application, the apparatus 100, with form factor similar to a credit card (85.6 mm×53.98 mm and a thickness less than 10 mm), may be added to the face of a computing device to add full keyboard input capabilities to a digital device. The apparatus 100 is preferably a peripheral widget that augments the function of the digital device and/or user interaction with the digital device.

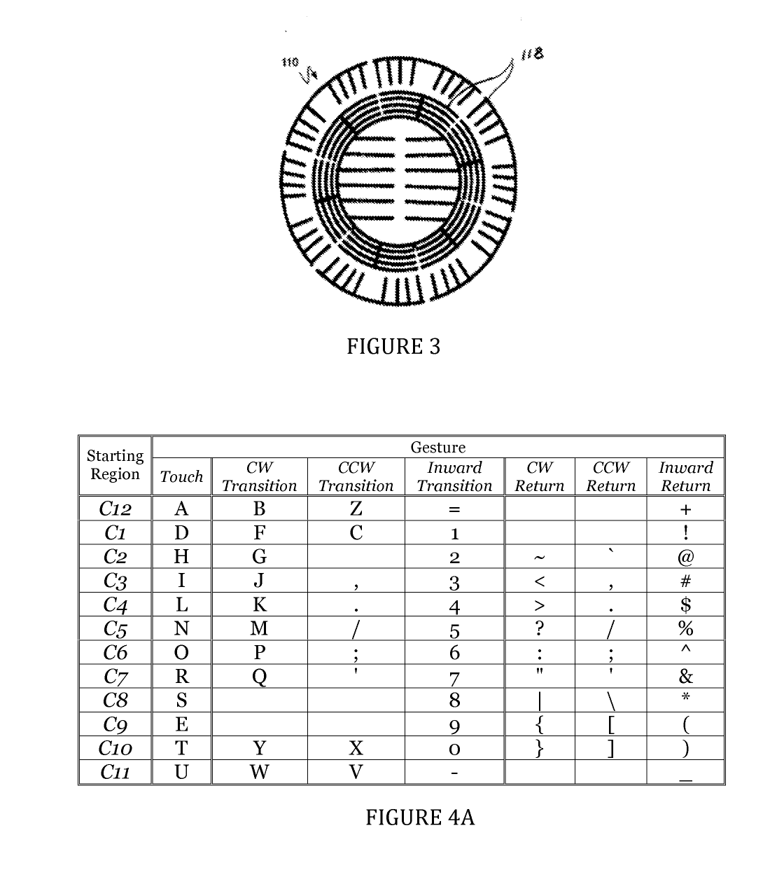

The touch sensitive array 110 of the preferred embodiment functions to detect touches on a plurality of touch regions within at least one touch input zone. The touch-sensitive array 110 preferably defines a first zone 112 that is divided into a plurality of touch regions, wherein the touch-sensitive array 110 detects unique touch events within the area defined by each region. The touch-sensitive array 110 preferably utilizes capacitive sensing to detect a user touch at a touch region. As shown in FIG. 3, the touch-sensitive array 110 preferably includes a conductive serpentine trace 118, as is commonly used for capacitive sensing. In an alternative embodiment, resistive touch sensing, optical sensing, or any suitable touch sensing technology may be used. The first zone 112 of the touch-sensitive array 110 is preferably circular in form and radially divided such that the regions of the first zone 112 are arranged in a circular path concentric with the first zone 112. However, the touch-sensitive array 110 may further comprise a plurality of zones, such as a second zone 114 of a single touch region and a third region of a plurality of touch regions, as shown in FIG. 1; additional zones of the touch-sensitive array 110 also preferably include circular borders that are concentric with the first zone 112. The touch-sensitive array 110 is also preferably substantially planar, but may alternatively be of any other form.

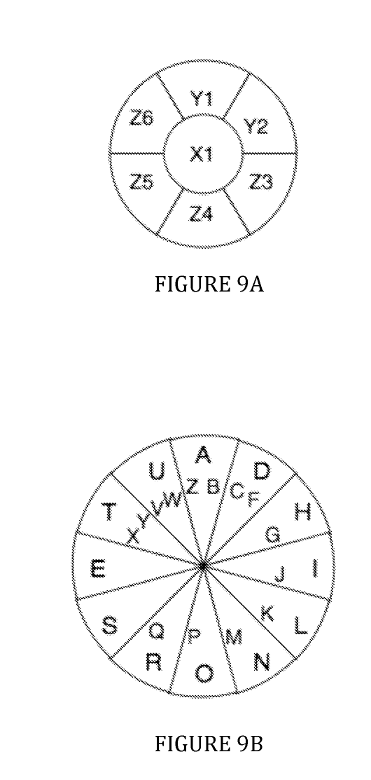

The arrangement of the zone(s) and regions may be of any pattern or layout. In a first variation shown in FIG. 9B, the apparatus 100 includes a single zone (i.e. the first zone 112), which is divided equally into different regions. In this variation, gestures are preferably input by the user by moving a finger (or other point of touch, e.g., a stylus) clockwise or counterclockwise from one region to an adjacent region. Character labels indicate the keys assigned to different gestures (i.e. transitions from one region to a second region). In a second variation shown in FIG. 9A, the apparatus 100 includes two zones, an outer first zone 112 with multiple regions and an inner second zone 114 with a single region. This arrangement may be used with gestures that have clockwise and counterclockwise transitions as well as radially inward and outward gestures. In a third variation, the apparatus 100 defines three zones, including an outer first zone 112, a middle third zone 116, and an inner second zone 114. The first zone is preferably divided into twelve regions; the third zone 116, four regions; and the second zone 114, a single region, as shown in FIG. 1. In this configuration, the seventeen touch regions may be used to provide: 1) seventeen single-region touches; 2) three times twelve inward, clockwise, and counterclockwise single-transition gestures originating in the first zone 112; 3) three times four inward, clockwise, and counterclockwise single-transition gestures originating in the third zone 116; and 4) four outward single-transition gestures originating in the second zone 116. Though limited to single taps and single-transition gestures, this configuration is capable of at least 69 different key (character and/or command) inputs.

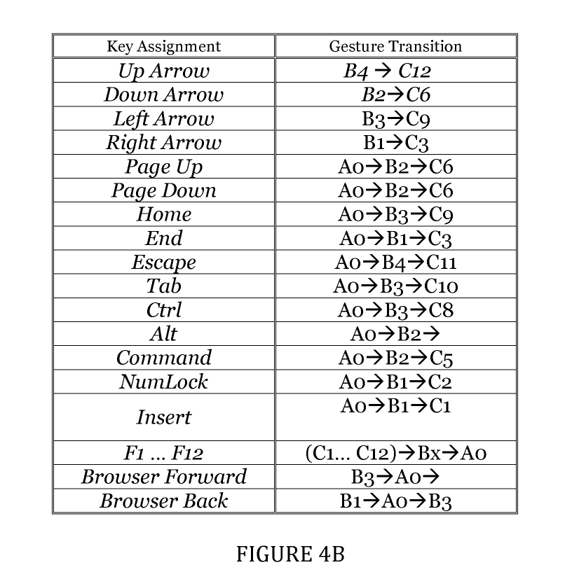

A user interaction initiating at the (outer) first zone 112 preferably causes the processor 120 to output a character (e.g., a number, a letter, a punctuation symbol, or an emoticon); a user interaction initiating at the (middle) third zone 116 and the (inner) second zone 114 preferably causes the processor 120 to output a command that controls a function of the digital device (e.g., tab, scroll up, scroll down, escape, home), as shown in FIG. 4B. However, there may be an overlap of character and command outputs for user touches originating at any of the zones; for example, user interaction initiated at the first zone 112 may exclusively lead to generation of characters, but tapping the single region of the second zone 114 may result in generation of a space (“ ”) or a period (“.”). The total number of touch regions defined by the touch-sensitive array 110 is preferably less than the number of alphabetical characters (i.e. less than 26). Despite this limited number of unique input regions, the apparatus 100 preferably retains substantially complete keyboard functionality with a wide variety of possible key (command and character) assignments, as shown in FIGS. 4A and 4B.

The processor 120 of the preferred embodiment functions to: communicate with the touch-sensitive array 110; determine the user input type; and generate an output that is a character (or command) associated with the user input type. The processor 120 is preferably a driver of the touch-sensitive array 110, but may alternatively be any suitable device or integrated circuit for processing interactions with the touch-sensitive array 110. The processor 120 preferably detects individual touches on a region and identifies transitions from one region to a second region of the touch-sensitive array 110 (i.e. a gesture). The processor 120 preferably recognizes a plurality of gesture types input into the touch-sensitive array 110, including: forward gestures comprising a single transition from a first region to an adjacent region; backtracking gestures comprising a transition from a first region to an adjacent region and a transition back to the first region; complex gestures comprising transitions between multiple regions, such as from a first region to a second region to a third region; and tapping gestures excluding transitions between regions.

In a first variation in which the touch-sensitive array 110 defines a single (first) zone including a plurality of regions, the processor 120 preferably distinguishes between various user input types for each region of the first zone 112, including: a first input type for a user tap on a region of the first zone 112; a second input type for a user touch on the region of the first zone 112 followed by a swipe in the counterclockwise direction and a touch release; and a third input type for a user touch on the region of the first zone 112 followed by a swipe in the clockwise direction and a touch release. In this variation, the first zone 112 preferably includes twelve touch regions in which the processor 120 recognizes between one and three input types per region, as depicted by the region labels shown in FIG. 1. However, the first zone 112 may include any other number of regions and the processor 120 may recognize any other number of input types per region.

In a second variation in which the touch-sensitive array 110 further defines a second zone 114 of a single region in which the second zone 114 is contained wholly within the first zone 112, the processor 120 preferably distinguishes between user input types for each region of the first and second zone 114s, including: the input types of the first variation above; a fourth input type for a user touch on a region of the first zone 112 followed by a swipe inward toward the second zone 114 and a touch release; and a fifth input type for a user touch on a region of the second zone 114 followed by a swipe outward toward a region of the first zone 112 and a touch release; and a sixth input type for a user tap on the second zone 114. In this variation, as shown in FIG. 1, the incorporation of the second zone 114 provides increased functionality to the apparatus 100 since inward and outward swipes may now be recognized as additional complex touch gestures that may be associated with additional characters and/or commands. For example, a fifth input type may engage “CAPS LOCK” and the fourth input type may disengage “CAPS LOCK”; the sixth input type may result in a character output that is a space, a command output that is “ENTER”, or any other character or command.

In a third variation in which the touch-sensitive array 110 further defines a third zone 116 of a plurality of regions in which the third zone 116 is contained wholly within the first zone 112 and the second zone 114 is contained wholly within the third zone 116, the processor 120 preferably distinguishes between user input types for each region of the first, second, and third zones 112, 114, 116, including: the input types of the first variation above; the input types of the second variation above; a seventh input type for a user touch on a region of the third zone 116 followed by a swipe toward a region of the first zone 112 and a touch release; an eighth input type for a user touch on a region of the third zone 116 followed by a swipe toward the region of the second zone 114 and a touch release; a ninth input type for a user touch on a region of the third zone followed by a swipe toward a second region of the third zone and a touch release; and a tenth input type for a user tap on the region of the third zone 116. In this variation, the first zone 112 preferably defines a substantially circular ring, of twelve touch regions, that surrounds the third zone 116; the third zone 116 defines a substantially circular ring, of four touch regions, that surrounds the second zone 114; and the second zone 114 defines a singular circular region concentric with the first and third zone 116s.

The processor 120 preferably associates at least one of the most commonly-used letters of the English language with a first input type for any region of the first zone 112. The most commonly-used letters in the English language include ‘a’, ‘e’, ‘h’, ‘i’, ‘n’, ‘o’, ‘s’, and ‘t’, and, as shown in FIG. 1, the first (outer) zone preferably has at least eight regions, wherein the processor 120 preferably associates one of the letters ‘a’, ‘e’, ‘h’, ‘i’, ‘n’, ‘o’, ‘s’, and ‘t’ with a first input type at each region of the first zone 112. However, the processor 120 may distinguish between user input types for each region of any number of zones defined by the touch-sensitive array 110 and associate any other command or character with any other input type. Furthermore, the zones of the apparatus 100 may be of any other shape or area, such as polygonal, rectilinear, elliptical, or amoebic.

The processor 120 preferably analyzes the user input at the touch-sensitive array 110, determines the input type, and generates an output that is a character or command. The output may be a single key (character or command) or a series of keys (and/or the output may be recognized by the digital device as a single key or a series of keys). The key associated with an input type may also be configurable, wherein the user (or other entity) may change the key that the processor 120 attaches to a given input type, which effectively changes the output of the apparatus 100.

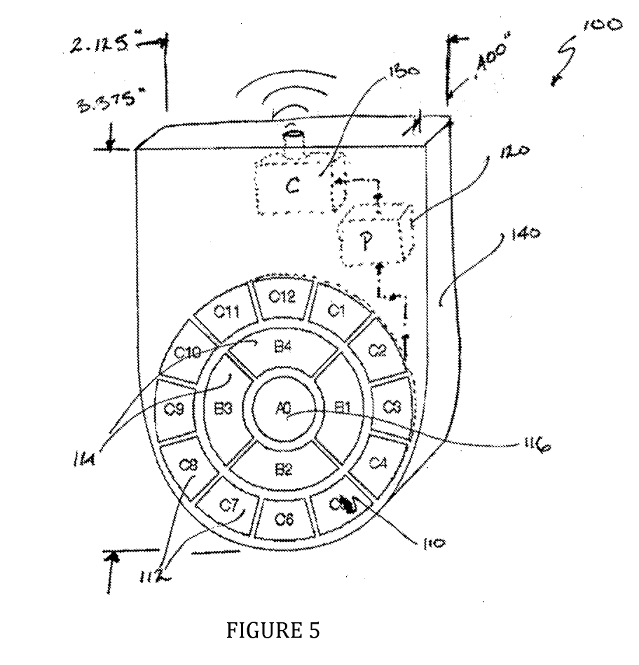

The communication module 130 of the preferred embodiment functions to transmit the output of the processor 120 to the digital device. The communication module 130 preferably transmits the output wirelessly, preferably via substantially near-field communication channels. For example, the communication module 130 may include a Bluetooth, radio frequency (shown in FIG. 2), infrared radiation (shown in FIG. 5), or Wi-Fi communication module. However, the communication module 130 may use substantially long-distance communication channels, such as satellite communications. The communication module 130 may further receive data or commands from the digital device, such as confirmation that an output was received or a call and subsequent commands from the digital device to control the apparatus 100 in a master-slave mode (with the digital device as the master). The communication module 130 (and/or the processor 120) may also encrypt the output before transmission to the digital device. For example, cryptographic protocols such as Diffie-Hellman key exchange, Wireless Transport Layer Security (WTLS), or any other suitable type of protocol, as well as encryption standards such as the Data Encryption Standard (DES), Triple Data Encryption Standard (3-DES), or Advanced Encryption Standard (AES) may be used. In this variation, the apparatus 100 preferably functions as a wireless remote control for the digital device that is any of a television, a gaming console, a DVD player, a stereo, a phone, a phone keypad, a smartphone, a tablet computer, a laptop computer, a desktop computer, an e-reader, or a wireless router.

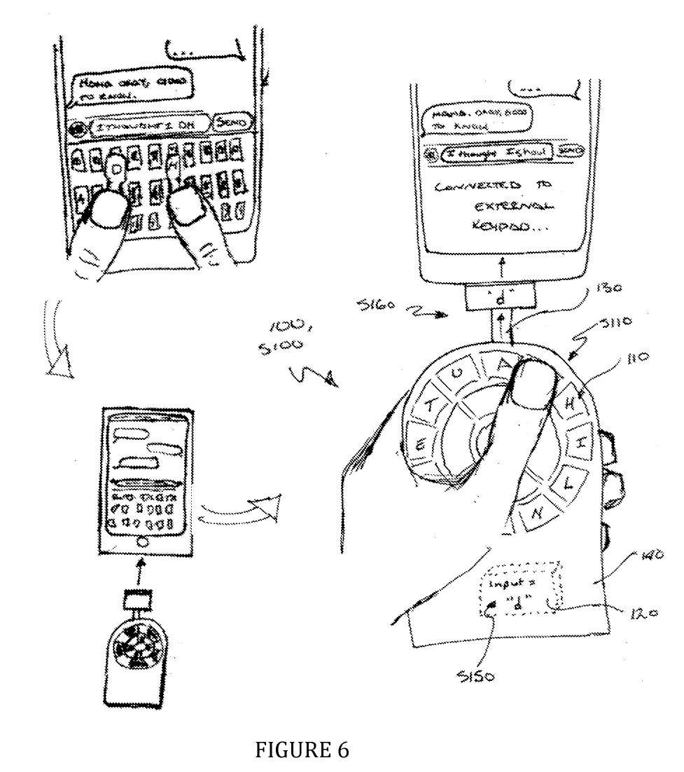

Alternatively, the communication module 130 may be a wired communication module, wherein the apparatus 100 connects to and transmits the output to the digital device via the wired connection. The wired connection may comprise a proprietary connector, such as the proprietary Apple iPhone/iPad/iPod 30-pin connector, or a standard connector, such as a USB, mini-USB, or micro-USB connector, or a ⅛″ headphone/microphone jack. The communication module 130 that is a wired connection may be permanently connected to the apparatus 100, but may alternatively be removable (i.e. is a wire with disconnect connections at each end), such as shown in FIG. 6, wherein the user plugs the apparatus 100 into the digital device (e.g., a smartphone). In the variation of the communication module 130 that is a wired connection, the apparatus 100 preferably derives power from the digital device through the wired connection to power the apparatus 100. For example the wired connection may comprise a single ground wire, a power (V+) wire to transmit current from the digital device to the apparatus 100, and an output wire to transmit the output to the digital device. In this example the wired connection may further comprise an input wire to receive commands from the digital device (similar to a USB cable).

The communication module 130 may transmit each output of the processor 120 serially to the digital device. Alternatively, the communication module 130 may transmit a plurality of outputs to the digital device at once. For example, the user may input a gesture that is followed by a pause on the gesture termination region; the pause preferably indicates a double character input (such as “ss” or “ee”) and the communication module 130 transmits both characters of the double character set together.

The casing 140 of the preferred embodiment functions to house the touch-sensitive array 110, the processor 120, and the communication module 130. As shown in FIG. 2, the casing 140 may further cover the face of the touch-sensitive array 110, such as with a sheath 144, to protect the touch-sensitive array 110. The casing 140 (or the sheath 144 of the casing) may also further define at least one of a ridge, bump, color change, or textural difference that aids the user in distinguishing between regions and/or zones of the touch-sensitive array 110. For example, in the variation that includes first, second, and third zones 112, 114, 116, the first (outer) and second (inner) zones 112, 114 may be smooth and the third (middle) zone 116 may include closely-spaced dimples; alternatively or additionally, the first zone 112 may be black, the third zone 116 may be gray, and the second zone 114 may be white. Adjacent regions may also be of different colors or textures.

Each region preferably includes key (character and/or command) labels that indicate the regions/touches/transitions that are involved in various recognized gestures. The labels are preferably arranged on the casing 140 and over the touch-sensitive array 110 to indicate to the user the character that the processor 120 associates with a particular input type (i.e. gesture), as shown in FIGS. 1 and 9B. These labels are preferably printed on the surface of the casing 140 over the touch-sensitive array no, but may also be engraved or embossed. A label is preferably positioned along each border between regions of the touch-sensitive array 110, wherein the regions may be in the same zone or different zones. Labels along a border preferably communicate to the user an origin and a transition (i.e., a sliding of a finger or stylus across the touch-sensitive array 110) that defines a particular gesture and results in a particular output character or command. The layout of concentric zones preferably provides a continuity of shared borders and allows an inner zone of even a single touch region to enable several transition possibilities, as shown FIG. 9A. In a preferred embodiment with a plurality of concentric zones, as shown in FIG. 1, a region of the first (outer) zone 112 preferably has: a first centrally-located key label that is associated with a non-transition gesture input for the region (i.e., tapping the region and not transitioning to another region); a second key label located within the same region but placed along the border between the region and an adjacent second region of the same zone, wherein the second region is clockwise from the region; a third key label located within the same region but placed along the border between the region and an adjacent third region of the same zone, wherein the third region is counterclockwise from the region; and a fourth key label along the inner circumference of the region and bordering an inner zone. A fifth key label may also be arranged along the outer circumference of the region bordering another zone that surrounds the first zone 112. Other labels may additionally be used, such as for regions that are radially staggered. An innermost zone that is only a single region may have any number of key labels describing outputs for transitions to any number of regions of an adjacent surrounding zone. For example, if the first zone 112 includes twelve regions and surrounds the second zone 114 that is a single region, the region of the second zone 114 may have thirteen key labels: a label for a transition to each region of the first zone 112 and a center key label for a tap in the second zone 114. The labels may additionally be color-coded or have other symbolic representation to reflect more complicated gestures (e.g., gestures that involve transitions between multiple regions).

The casing 140 may be of any suitable material or combination of materials and manufactured by any suitable manufacturing method. For example, the casing 140 may generally be of injection molded plastic (such as nylon, ABS, or polyethylene), but the casing 140 may further comprise a thin silicone sheath over the touch-sensitive array 110. This silicone sheath 144 may be clamped or screwed in place, or, alternatively, the silicone sheet may be molded in place. However, the casing 140 (and sheath 144) may be of any other hard or soft material, such as steel, aluminum, silicone, glass, ceramic, or other polymer; the casing 140 may be manufactured by any other method or combination of methods, such as casting, machining, spinning, turning, vacuum forming, or molding.

The casing 140 is preferably substantially thin and is preferably of a geometry that is comfortable to hold and to operate with a single finger (such as a thumb of the user). However, the casing 140 preferably has a footprint that facilitates transport of the apparatus 100, such as in a pocket, wallet, purse, backpack, or satchel. As shown in FIG. 6, the apparatus 100 is preferably less than 0.500″ in thickness and the footprint of the apparatus 100 is preferably substantially similar to the footprint of a credit card, such as 3.375″×2.125″. However, the casing 140 may define any other thickness and/or footprint. The case may further comprise a mounting element that attaches the apparatus 100 to the digital device. This mounting element may be a clip, clamp, strap, adhesive, sleeve, case, cover, or any other suitable element that achieves this desired function.

In the variation in which the communication module 130 comprises a wireless communication module, the casing 140 may further define a cavity that receives at least one battery to power the apparatus 100. In this variation, the casing 140 preferably comprises multiple sections, at least one of which is removable to facilitate battery replacement. Alternatively, in a variation in which the battery is irremovable from the casing 140 but is rechargeable, the casing may 140 further contain a battery-charging jack such that the battery may be recharged.

The casing 140 may contain any additional elements. For example, the casing 140 may house a display that depicts a selected key for the user (e.g., the character or command associated with a user input). The display may be an LCD, LED, ELD, or other type of digital display. The display may also be a touch screen, wherein the touch-sensitive array 110 is arranged within the touch screen such that the region labels are presented on the display of the touch screen and the touch-sensitive array 110 is the touch sensor of the touch screen and detects a user touch on the touch screen.

### 2. Method for Providing Keyboard Functionality

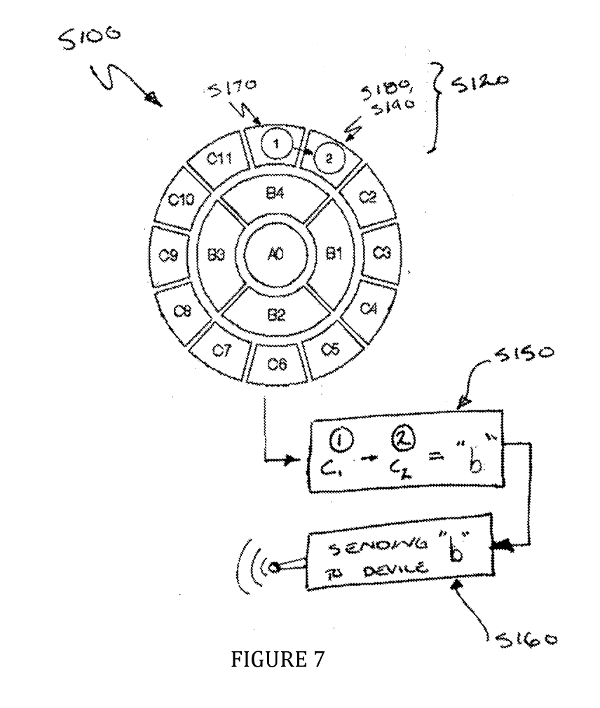

As shown in FIG. 7, a method for providing keyboard functionality, via a limited number of input regions, to a separate digital device, by receiving gesture-based touch inputs from a user, includes the following steps: determining a user touch and release at a first touch region of a first zone on a touch-sensitive array to be a first input type S110; determining a user touch at the first touch region of the first zone and a transition to and release from a second region of the first zone on the touch sensitive array to be a second input type S120; determining a user touch at the first touch region of the first zone and a transition to and release from a region of a second zone on the touch sensitive array to be a third input type S130, wherein the second zone is arranged wholly within the first zone; determining a user touch and release at the touch region of the second zone on the touch sensitive array to be a fourth input type S140; generating an output that is a character, wherein the character is associated with the determined input type S150; and transmitting the output to the digital device S160.

The steps of determining the input type preferably include that steps of: detecting a touch event in a first region of a touch sensitive array S170; detecting a transition from the first region to a second region of the touch sensitive array S180; and detecting a touch release from a region of the touch-sensitive array S190. The method functions to provide substantially compete keypad functionality (i.e. substantially all alphanumeric characters, punctuation, and typical keyboard commands) with a limited number of touch sensitive regions (i.e. fewer input regions/buttons than typical keyboards). Additionally, the method functions to enable multiple characters and/or computer actions to be assigned to user touches at individual touch regions, wherein these touches are limited to single actions (e.g., not repeated taps). The method is preferably used in combination with an input apparatus with a touch sensitive array, such as the apparatus 100 described above, but may alternatively be used for any suitable device. Additionally, the method may be used with a virtual keypad such as on a touch screen of a cellular phone. The touch-sensitive array is preferably as described above, i.e. composed of a plurality of zones with distinct touch regions, wherein the zones and regions are arranged in a ring-like formation. The ring formation preferably functions to create an intuitive arrangement and optimization of borders for sensing touch gestures, but any formation of regions of a touch-sensitive array may be used. The method of the preferred embodiment preferably includes the functions performed by the processor 120 of the apparatus 100 described above. The method is preferably utilized for a full keypad so that a large range of keys (characters and/or commands) may be selected using the method.

Steps S110, S120, S130, and S140 function to capture a user input such that the input may be transformed into an output character or command in step S150. To capture the user input, steps S170, S180, and S190 are preferably performed.

Step S170, which includes detecting a touch event in a first region of a touch sensitive array, functions to determine an initial starting point of a touch event. The touch event is preferably the placing of a finger (or a stylus or other pointing device) within a touch region of the touch-sensitive array. The touch event may alternatively be triggered by any other suitable action to select a character, command, key, or button. The detection of a touch event is preferably through a conductive touch-sensitive component but may alternatively be by a resistive touch-sensitive component or any suitable touch sensing technology. A touch sensor driver (e.g., a processor) preferably stores the initial position of the touch. In some embodiments, the method may be applied to a virtual keypad. In some cases, the user may remove the contacting finger (or stylus) prior to transitioning to an adjacent second region; a key (command or character) designated to a single touch (i.e. tap) of the region is preferably selected for this action.

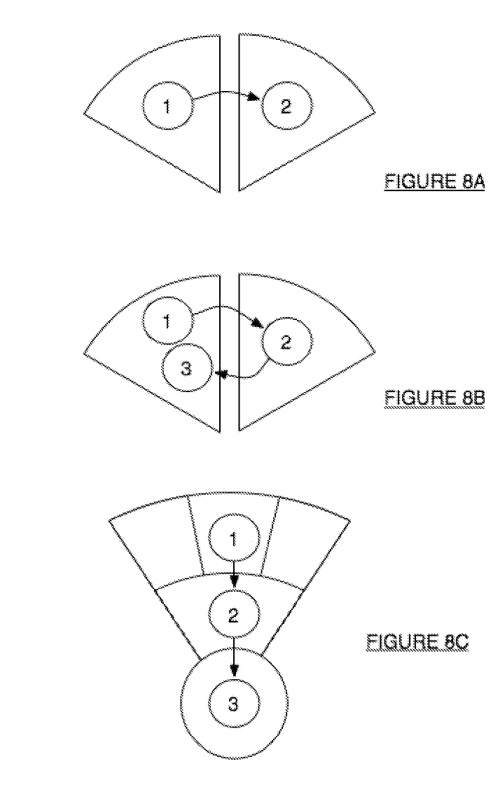

Step S180, which includes detecting a touch transition from the first region to the second region, functions to sense a substantially uninterrupted sequence of touches between different touch regions (i.e. a swipe from the first region to at least one second region without a touch lift). Gestures are preferably characterized by continuous touch contact from the first region to the second region; any number of additional regions may be contacted between the beginning of the gesture at the first region and the completion of the gesture at the second region. Preferably, the touch transition originates at a first region and terminates at a second region that is adjacent to the first region. The adjacent touch region may be in the same zone, such that the transition is in a clockwise or counter clockwise direction, or in a different zone, such that the transition is in a radially outward or inward direction. A transition is preferably detected when the user touch moves from one region to a neighboring region, as shown in FIGS. 7 and 8A. There is preferably no delay (or sensing of a “no touch event”) between sensing of a touch in the first region and a touch transition to the second region; however, there may be a threshold of allowable loss of touch detection (e.g., less than 0.25 seconds) during a touch transition. This threshold may function to account for a space between two regions in which touch detection sensitivity is limited, such as due to the geometry of the touch-sensitive array. When detection of multiple points of contact is possible by the touch sensitive array, there may also be a requirement for a transition to include simultaneous detection of a touch in the first region and a touch in the second region. For example, touch transition detection may include: recognizing that the first region is “touched” when a finger (or stylus) is fully within the first region; detecting a touch in the first and second regions when the finger (or stylus) is on a border between the first and second regions; and recognizing a touch in the second region when the finger (or stylus) is fully within the second region. Alternatively, a touch transition may be characterized by other gesture path patterns. Detection of the gesture shown in FIG. 8B—a transition from a first region to a bordering second region and returning to the first region—functions to assign a back-and-forth-type gesture. As shown in FIG. 8C, detection of a transition from a first region to a bordering second region and then to a third region that borders the second region functions to detect a complex gesture that involves more than two regions. This second gesture may be expanded to include a gesture with any suitable number of region transitions.

Step S160, which includes generating an output character (or command) based upon the input type, functions to activate the key associated with the user input (e.g., gesture). The selected key is preferably interpreted by the digital device as a character but may alternatively be a command that controls a function of the digital device; however, the key may be interpreted in any other suitable way by the digital device. As shown in FIGS. 4A and 4B, a wide variety of gesture-to-key assignments may be made.

The selected character or command generated as a result of the transition is preferably communicated to the user by labels along borders of the regions as described above. For more complicated transitions, such as transitions that involve multiple touch regions, color-coding or any suitable labeling may be used to indicate the required gesture. The selected key is preferably submitted as an input to the device for which the apparatus is being used.

Furthermore, the method may include the step of detecting a prolonged touch event as a fifth input type, wherein a unique character (or command) is associated with the fifth input type. The fifth input type is preferably utilized to toggle character selection, such as when entering a capital letter. The prolonged touch event may alternatively indicate double character entry (e.g., “ss”), accented letter selection (e.g., ä, é, õ), or any suitable key selection. The prolonged touch event is preferably a touch of substantially longer in duration than a normal (i.e., typical) touch in a region of the touch-sensitive array. The prolonged touch event may be assigned a particular time (e.g., greater than one second), but may alternatively be adapted to the input speed of a user (e.g., twice the average amount of time that the user touches a region or typically requires to release from a touch region). The prolonged touch event is preferably applied to the termination region of a gesture, but may alternatively be the duration of a complete gesture (i.e., time from initial touch at a touch region to termination of the gesture), the duration of a touch at the gesture origin, or the duration of a touch at an intermediate region of the gesture.

An alternative embodiment preferably implements the above methods in a computer-readable medium storing computer-readable instructions. The instructions are preferably executed by computer-executable components preferably integrated with a touch sensitive array. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

As a person skilled in the art will recognize from the previous detailed description and from the figures and claims, modifications and changes may be made to the preferred embodiments of the invention without departing from the scope of this invention as defined in the following claims.

We claim:

1. An apparatus that receives gesture-based touch inputs from a user to provide keyboard functionality, via a limited number of input regions, to a separate digital device, the apparatus comprising:
a touch-sensitive array that defines a first zone with a plurality of radially-arranged touch regions, wherein the touch-sensitive array detects user touches at the regions of the first zone;
a processor in communication with the touch-sensitive array, wherein the processor distinguishes between various user input types for each region of the first zone, including:
a first input type for a user tap on a region of the first zone;
a second input type for a user touch on the region of the first zone followed by a swipe in the counterclockwise direction to an adjacent touch region and a touch release; and
a third input type for a user touch on the region of the first zone followed by a swipe in the clockwise direction to an adjacent touch region and a touch release;
wherein the processor generates an output that is a character associated with the input type;
a communication module that transmits the output to the digital device; and
a casing that substantially houses the touch-sensitive array, the processor, and the communication module.

2. The apparatus of claim 1, wherein the touch-sensitive array is substantially planar.

3. The apparatus of claim 1, wherein the processor associates the first input type with at least one of the following letters in the English language of ‘a’, ‘e’, ‘h’, ‘i’, ‘n’, ‘o’, ‘s’, and ‘t’.

4. The apparatus of claim 1, wherein the total number of touch regions defined by the touch-sensitive array is less than the number of alphabetical characters.

5. The apparatus of claim 1, wherein the processor further generates an output that is a command, wherein the command controls a function of the digital device and is associated with an input type.

6. The apparatus of claim 5, wherein an input type is configurable to be associated with at least one of a character and a command that controls a function of the digital device.

7. The apparatus of claim 1, wherein the communication module transmits each character output of the processor serially.

8. The apparatus of claim 1, wherein the touch sensitive array further defines a second zone with a single touch region, wherein the second zone is concentrically arranged within the first zone, and wherein the touch-sensitive array further detects a user touch at the second zone.

9. The apparatus of claim 8, wherein the processor further distinguishes between user input types for each region of the first and second zones, including:
a fourth input type for a user touch on a region of the first zone followed by a swipe inward toward the second zone and a touch release;
a fifth input type for a user touch on a region of the second zone followed by a swipe outward toward a region of the first zone and a touch release; and
a sixth input type for a user tap on the second zone.

10. The apparatus of claim 9, wherein the processor associates the sixth input type with a space character.

11. The apparatus of claim 8, wherein the touch sensitive array further defines a third zone of a plurality of touch regions, wherein the third zone is concentrically arranged within the first zone and the second zone is concentrically arranged within the third zone, and wherein the touch-sensitive array further detects user touches at the regions of the third zone.

12. The apparatus of claim 11, wherein:
the first zone defines a substantially circular ring, of twelve touch regions, that surrounds the third zone;
the third zone defines a substantially circular ring, of four touch regions, that surrounds the second zone; and
the second zone defines a singular circular region concentric with the first and third zones.

13. The apparatus of claim 11, wherein the processor further distinguishes between user input types for each region of the first, second, and third zones, including:
a seventh input type for a user touch on a region of the third zone followed by a swipe toward a region of the first zone and a touch release;
an eighth input type for a user touch on a region of the third zone followed by a swipe toward the region of the second zone and a touch release;
an ninth input type for a user touch on a region of the third zone followed by a swipe toward a second region of the third zone and a touch release;
a tenth input type for a user tap on the region of the third zone.

14. The apparatus of claim 8, further comprising at least one of a ridge, bump, color change, and textural difference that distinguishes a region of the first zone from a region of the second zone.

15. The apparatus of claim 1, further comprising at least one label over the touch-sensitive array to indicate to the user a character that the processor associates with an input type.

16. The apparatus of claim 1, wherein the touch sensitive array incorporates capacitive sensing to detect the user touch.

17. The apparatus of claim 16, wherein the touch sensitive array includes a serpentine trace.

18. The apparatus of claim 1, wherein the communication module is a wireless communication module, wherein the output of the processor is sent wirelessly to the digital device.

19. The apparatus of claim 18, wherein the apparatus functions as a wireless remote control for the digital device, and wherein the digital device is selected from the group consisting of a television, a gaming console, a DVD player, a stereo, a phone, a phone keypad, a smartphone, a tablet computer, a laptop computer, a desktop computer, an e-reader, and a wireless router.

20. A method for providing keyboard functionality, via a limited number of input regions, to a separate digital device, by receiving gesture-based touch inputs from a user, the method comprising the steps of:
determining a user touch and release at a first touch region of a first zone on a touch sensitive array to be a first input type;
determining a user touch at the first touch region of the first zone and a transition to and release from a second region of the first zone on the touch sensitive array to be a second input type;
determining a user touch at the first touch region of the first zone and a transition to and release from a region of a second zone on the touch sensitive array to be a third input type, wherein the second zone is arranged wholly within the first zone;
determining a user touch and release at the touch region of the second zone on the touch sensitive array to be a fourth input type;
generating an output that is a character, wherein the character is associated with the determined input type; and
transmitting the output to the digital device.

21. The method of claim 20, further comprising the step of generating an output that is a command, wherein the command controls a function of the digital device and is associated with an input type.

22. The method of claim 20, further comprising the step of determining a prolonged touch event as a fifth input type.

23. The method of claim 22, wherein the step of generating an output based on the input type includes:
generating a capitalized version of a character for a gesture path that is followed by a substantially prolonged hold before release; and
generating a lowercased version of the character for a similar gesture path that is followed by a substantially quick release.

24. The method of claim 20, wherein the step of determining the user input type includes sensing an output of the touch-sensitive array, wherein the touch-sensitive array includes the first and second zones and wherein the first zone includes a plurality of touch regions arranged radially around and concentric with the second zone that includes a single circular touch region.

25. The method of claim 20, wherein the steps of determining the input type include the steps of:
detecting a touch event in a first region of the touch-sensitive array
detecting a transition from the first region to a second region of the touch-sensitive array; and
detecting a touch release from a region of the touch-sensitive array.
